(19) United States
(12) Patent Application Publication
(10) Pub. No.: US 2012/0166561 A1
(43) Pub. Date: Jun. 28, 2012

(54) Multi-Channel Dynamic Response Communication Engine

(76) Inventor: Julius Kelly, Long Beach, CA (US)

(21) Appl. No.: 13/338,861

(22) Filed: Dec. 28, 2011

Related U.S. Application Data
(60) Provisional application No. 61/427,568, filed on Dec. 28, 2010.

(51) Int. Cl. G06F 15/16

(52) U.S. Cl. 709/206; 709/217

(57) ABSTRACT

An interactive communication system in which a communication established between a user and a content provider comprises of a plurality of disparate communication devices for engaging at least one user, a plurality of gateways in communication with the plurality of disparate communication devices, a multi-channel proxy service, a response engine, a message push engine, a message push scheduler and a content database. The response engine has a dynamic response engine and a just in time response engine. The interactive communication system having an inherent ability to anticipate a response from a user have the ability to construct an expected and coherent response dynamically to the user. The interactive communication system is also capable of completing and/or continuing communication through a time tagged data management. The interactive communication can be obtained by broadcasting a message to a user and receiving a reply from the user for training, quizzing, studying, polling and surveying.

### CROSS-REFERENCE TO RELATED APPLICATIONS

This application claims the benefit of PPA Serial No. 61/427,568, filed Dec. 28, 2010 by the present inventor.

### STATEMENT REGARDING FEDERALLY SPONSORED RESEARCH AND DEVELOPMENT

Not Applicable.

### FIELD OF THE INVENTION

This embodiment relates to the field of content management and delivery, and more particularly to an interactive communication system.

### DISCUSSION OF RELATED ART

Content management and delivery systems allow managing and processing content and deliver to any device content over any network to any device whether local or remote. A wide variety of content management and delivery systems have been developed in the art. Content management plays a crucial role in on-line learning and e-commerce.

With the increased demand for delivery of content, XML-based content management systems are getting well noticed. The xml based systems allows content reuse and allows delivering the content across multiple channels and in different versatile formats. However, conventional content management and delivery systems have considerable drawbacks.

U. S. Pat. No. 7,321,920 issued to Washburn on Jan. 22, 2008, provides an interactive messaging system for an interactive communication process between users, both senders and recipients. The sender composes a message by filling in a template stored in data services. Once completed, the sender pushes the message to a recipient's wireless device if the wireless device contains a WAP browser which is capable of receiving pushed messages. Typically the message includes a question along with answers for the recipient to choose from. Each answer corresponds with a pre-assigned response key and the recipient answers the question by selecting one of the pre-assigned response keys. The recipient's response is available to the sender in the form of an e-mail, WAP Push, on-line access or interactive message that is shown to the sender on an on-line status screen. However, the interactive communication process involves usage of a template for filling in any data and a pre-assigned response key making flexibility of message to be sent to the recipients limited and hence the system is inefficient for a dynamic communication between senders and recipients.

U. S. Pat. No. 7,619,584 issued to Wolf presents an enhanced messaging capability which enables the recipient of the message to respond to a query by pressing a single button or multiple buttons to issue the response. Code for enabling a receiving device to display the message and provide simplified response options is carried by a messaging format such as SMS, MMS etc., in which a web browser application is not required nor invoked to permit active response functionality. A mechanism is provided to allow delivery of response in a variety of formats. The system may automatically take a selected action if a response is not received within a present time period. A message and response system greatly simplified from the senders and recipients' perspective is provided. However, the option available for a user for interactive communication is limited to SMS and MMS and thus restricts the interactive communication of user over mobile phone only.

U.S. patent application No. 20100211489 entitled to Zhang on Aug. 19, 2010 describes a content management and delivery system comprising a plurality of communication devices and a content server is provided. Each of the plurality of communication devices has a display panel for enabling haptic interaction with data displayed thereon. The content server is coupled to the plurality of communication devices. At least one of the plurality of communication devices is to receive the data from the content server, generate a response corresponding to a user interaction with the data displayed on the display panel and transmit the response to the content server. The data is customizable to provide a plurality of user selectable options for facilitating user interaction therewith. However, the application of the content management and delivery system is limited only to hospitality management.

Therefore, there is a need for an interactive communication system that is flexible in regards to the type of messages sent to the recipients thereby obtaining a dynamic communication between senders and recipients. Such an interactive communication system would be easy to use for training, quizzing, studying, polling and surveying. In addition, an interactive communication system that is compatible with all types of data delivery application. The present invention accomplishes these objectives.

### SUMMARY OF THE INVENTION

The present invention is an interactive communication system comprising a plurality of disparate communication devices for engaging at least one user wherein a plurality of gateways is in communication with the plurality of disparate communication devices. The plurality of gateways includes short message service (SMS) gateway, Email gateway, custom Instant Message (IM) gateway and Hyper Text Transfer Protocol (HTTP) gateway. A multi-channel proxy is utilized to receive and/or send out at least one data through the plurality of gateways. A response engine is in communication with the multi-channel proxy for processing at least one data to the plurality of disparate communication devices. The multi-channel proxy receives requests from the plurality of gateways and directs requests to the response engine.

The response engine includes a dynamic response engine (DRE) and a just in time response engine (JITRE). A standardized XML representation of a workflow with which the DRE responds to message request from the at least one user is called Dynamic Conversation Markup Language (DCML). The JITRE launches a session for any data on demand by a code. A message push engine in communication with the multi-channel proxy for completion and/or continuation of communication through a time tagged data management. The idea of a “push” is a schedule or event driven delivery of a message to the at least one user at any endpoints. A message push scheduler is operable with the message push engine for initializing the time tagged data management. A content database is in communication with the response engine and the message push scheduler having a content management system. The content database contains data for responding to requests from the user and for delivery of the time tagged data management.

The present invention has an inherent ability to anticipate a response from a user and have the ability to construct an expected and coherent response dynamically to the user. Additionally, the multi channel proxy is engineered to be a generic proxy for nearly all types of content delivery applications that exists today.

### DESCRIPTION OF THE DRAWINGS

FIG. 1 shows an architecture of an interactive communication system which establishes a communication between a user and a content provider by way of a plurality of disparate communication devices;

FIG. 2 is a flowchart depicting a method for content management and delivery application utilizing the plurality of disparate communication devices;

FIG. 3 is a workflow through which a dynamic response engine (DRE) and a content database facilitate an interaction with at least one user;

FIG. 4 illustrates a window/webpage for a user registration in accordance with the present invention;

FIG. 5 illustrates a window/webpage for a content provider registration in accordance with the present invention;

FIG. 6 illustrates a window/webpage for a user profile in accordance with the present invention;

FIG. 7A shows an example of a push message received by at least one user on a plurality of disparate communication devices which is a mobile phone of the at least one user;

FIG. 7B shows an example of a response received by at least one user on a plurality of disparate communication devices, which is a mobile phone of the at least one user, for a push message;

FIG. 8 illustrates a flow chart describing the working of a just in time response engine in accordance with the present invention;

FIG. 9A shows an e-learning program attended by at least one user through at least one of the plurality of disparate communication devices, which is a mobile phone of the at least one user, and depicting an inherent ability of a response engine to anticipate and construct an expected and coherent response dynamically to the at least one user;

FIG. 9B shows a response from a response engine during an e-learning program attended by at least one user through a plurality of disparate communication devices, which is a mobile phone of the at least one user, depicting an inherent ability of a response engine to anticipate and construct an expected and coherent response dynamically to the at least one user of FIG. 9A.

### DETAILED DESCRIPTION OF THE PREFERRED EMBODIMENT

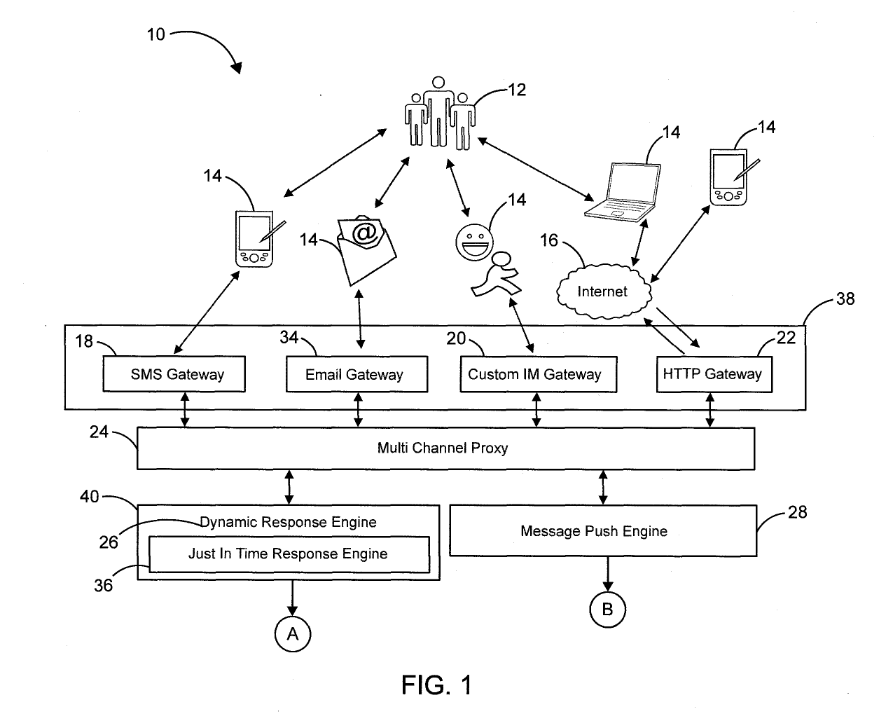

FIG. 1 shows an architecture of an interactive communication system 10, which comprises a plurality of disparate communication devices 14 for engaging at least one user 12. The communication devices include but is not limited to mobile phones, tablets, PC's MACs, or any device capable of accessing a mobile network. A plurality of gateways 38 is in communication with the plurality of disparate communication devices 14. The plurality of gateways includes short message service (SMS) gateway 18, Email gateway 34, custom Instant Message (IM) gateway 20 and Hyper Text Transfer Protocol (HTTP) gateway 22. Any mobile subscriber can opt to send and receive text messages from SMS application compliant communication device 14, through the SMS gateway 18. An Email uses POP/SMTP for communication via Email gateway 34. An Instant Messenger (IM) compliant communication device 14 utilizes a standard protocol to transfer secured texts. IM compliant communication device 14 uses a standard protocol and maintaining software to keep up with communications through the custom IM gateway 20. HTTP gateway 22 is a common protocol for Internet data transmission. The system 10 utilizes a common protocol for interactive communication. A multi-channel proxy service 24 is utilized to receive and/or send out at least one data through the plurality of gateways 38. A response engine 40 is in communication with the multi-channel proxy service 24 for processing at least one data to the plurality of disparate communication devices. The multi-channel proxy service 24 receives requests from the plurality of gateways 38 and directs requests to the response engine 40. The response engine 40 includes a dynamic response engine (DRE) 26 and a just in time response engine (JITRE) 36. The DRE 26 is a message processing engine that is responsible for responding to the message requests from the at least one user 10 by way of the plurality of disparate communication devices 14 through the multi channel proxy 24 in a standardized XML format. The standardized XML representation of a workflow with which the DRE responds to message request from the at least one user is called Dynamic Conversation Markup Language (DCML). The XML is serialized into objects that are then utilized in the workflow to determine the next step, next message, and any specific requirement defined by the workflow. The DCML object persists data to the database as well as to retrieve, process, manipulate, and cache. The JITRE 36 launches a session for any data on demand by a code. A message push engine 28 in communication with the multi-channel proxy 24 for completion and/or continuation of communication through a time tagged data management. The idea of a “push” is a schedule or event driven delivery of a message to the at least one user 12 at any endpoints. An endpoint is a point of which the at least one user 12 will receive the message, which can be via IM, SMS, Chat and Email. Examples of a push message type can be a sponsor advertisement, quick vote, reminder, poke, notifications and quick session. A message push scheduler 30 is operable with the message push engine 28 for initializing the time tagged data management. The message push scheduler 30 is managed by various services like sponsor advertisement, quick vote, reminder, poke, notifications and quick session. A content database 41 is in communication with the response engine 40 and the message push scheduler 30 having a content management system. The content database 41 contains data selected from a group consisting of quizzes, exams, tests, surveys, polls, trivia advertisements and the like. The content database 41 contains data for responding to requests from the user and for delivery of the time tagged data management. The content database 41 contains data for response engine 40 that is responsible for responding to requests from the user. The data in content database 41 for the message push scheduler 30 can be sponsor advertisement, quick vote, remainder, request for continuing, poke and notification while quizzes, exams, tests, service, trivia, and polls which are the data for the response engine 40. The data in the content database 41 can be made private or public to the at least one user 12 which responds to the response engine 40.

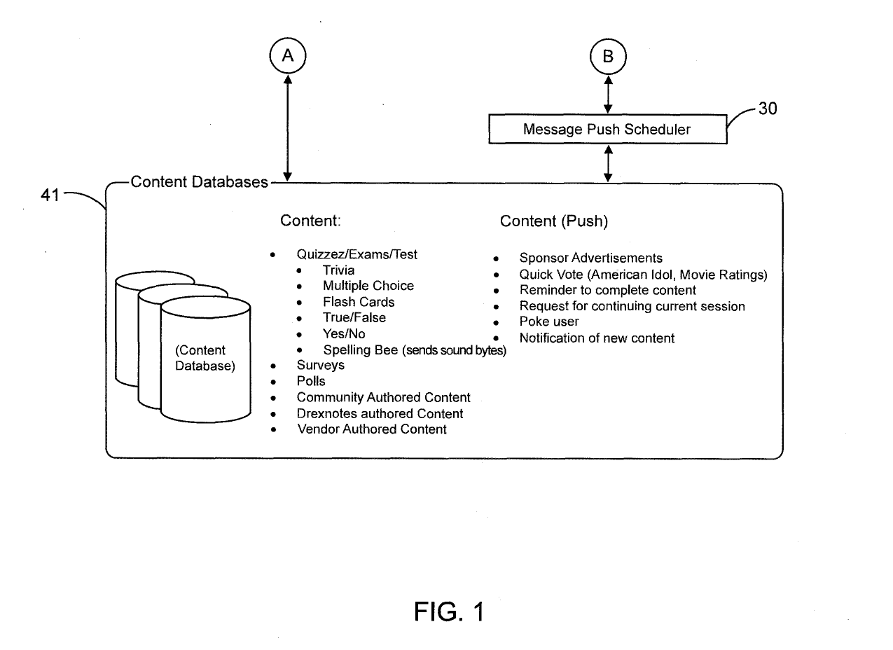

FIG. 2 is a flowchart depicting a method for content management and delivery application utilizing a plurality of disparate communication devices 14. The method is initiated by creating a user account by at least one user at a user interface as indicated at block 42. Block 44 shows registration by at least one content provider at the user interface. Then data is added by the content provider or alternatively may be added by the user at a content database as depicted at block 46. The content may be imported or via a user interface. Finally as shown in block 48, the data is made accessible to the at least one user upon a request by the at least one user. The content provider may be, but not limited to bars, restaurants, law firms, advertisers and e-learning programs. Accessibility of the content can be controlled by the user or the content provider by electing to make content public or private to group or selection of users.

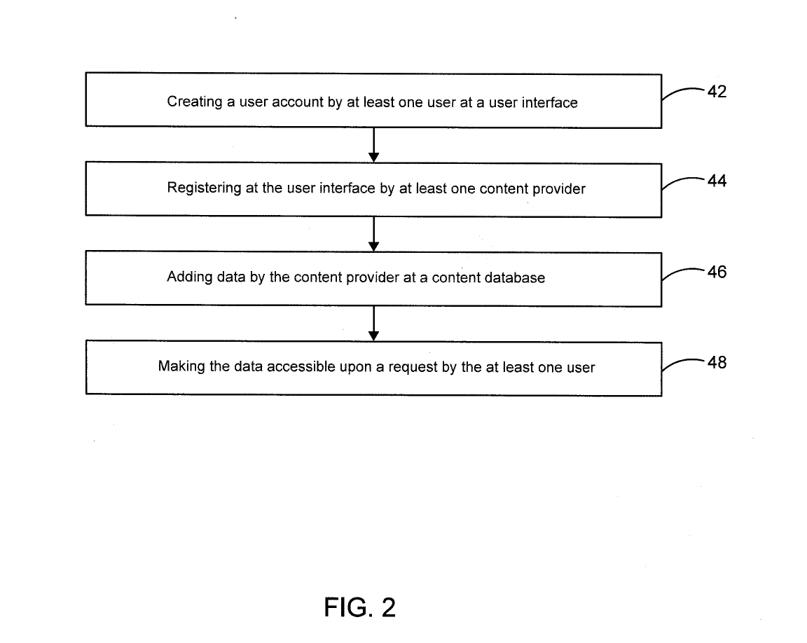

FIG. 3 is a workflow through which a dynamic response engine (DRE) and a content database facilitate interaction with at least one user. The workflow starts with the at least one user sending a message as depicted at block 50. The DRE checks whether the at least one user is new as in block 52. If the at least one user is new, then a temporary user profile is created and allows the at least one user to use the DRE as depicted in block 56. The DRE keeps association of the temporary user profile with the at least one user who is knew. If the at least one user exists as in block 54 the DRE gets a chat history of the at least one user from the content database and loads previous chat as shown in block 58. As depicted in block 60, the DRE loads current chat history and as in block 62 the DRE checks whether the current chat history logically parse with the previous chat. If the current chat history logically parses with the previous chat then the DRE will execute as in block 64, or else a default message is loaded, like “Hello, the application doesn't understand your request. Please select an option below:”A.) Continue my last session B.) Choose an active session C.) Search for content M.) Main Menu as in block 66.

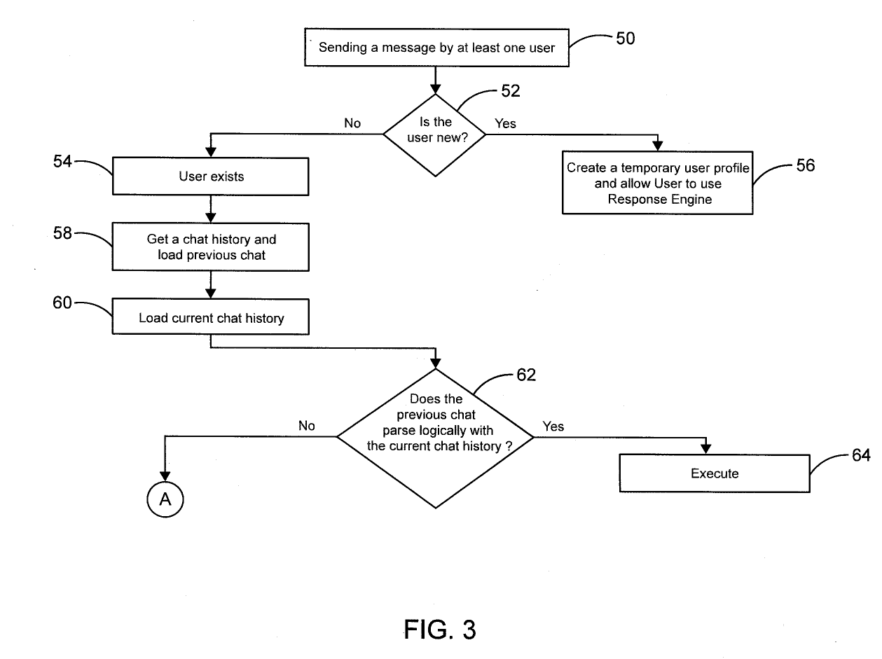

FIG. 4 illustrates a window or a webpage 82 for a user registration in accordance with the present invention. In the user registration, the at least one user 12 can enter data such as user name, mobile phone number, password, security question, answer to security question, email address, birthday, name, address etc. The at least one user 12 can add a photo.

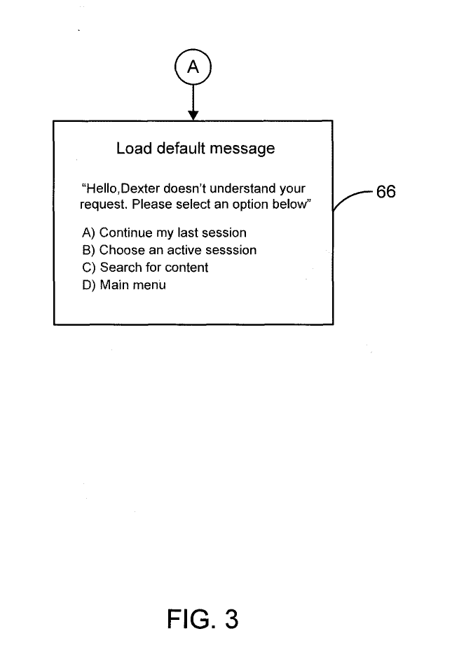

FIG. 5 illustrates a window or a webpage 84 for a content provider registration in accordance with the present invention. The window or a webpage allows the content provider registration wherein the plurality of content provider can enter data such as user name, mobile phone number, password, security question, answer to security question, email address, birthday, name, address etc. The plurality of content providers can add a logo too.

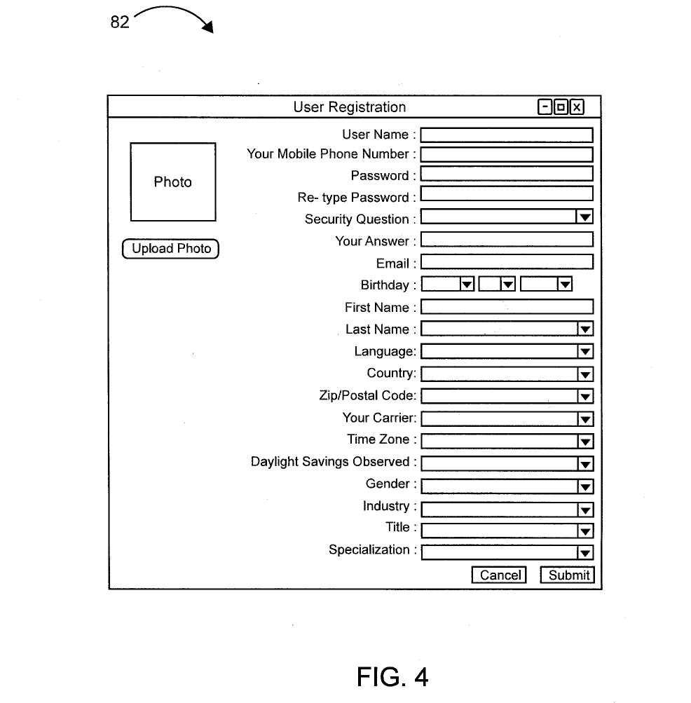

FIG. 6 illustrates a user profile of present invention 86. In the user profile, data user name, mobile phone number, Email id, mode of communication and photo can be viewed. There is an option to edit the user profile.

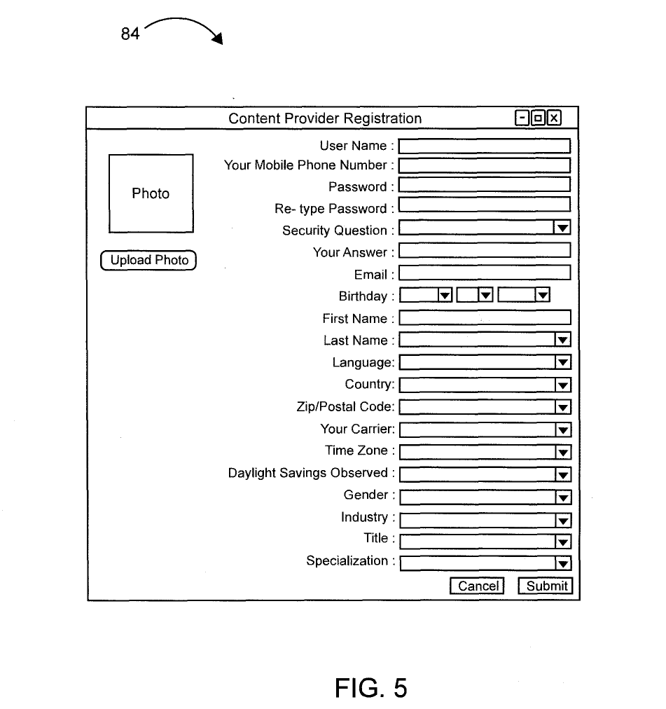

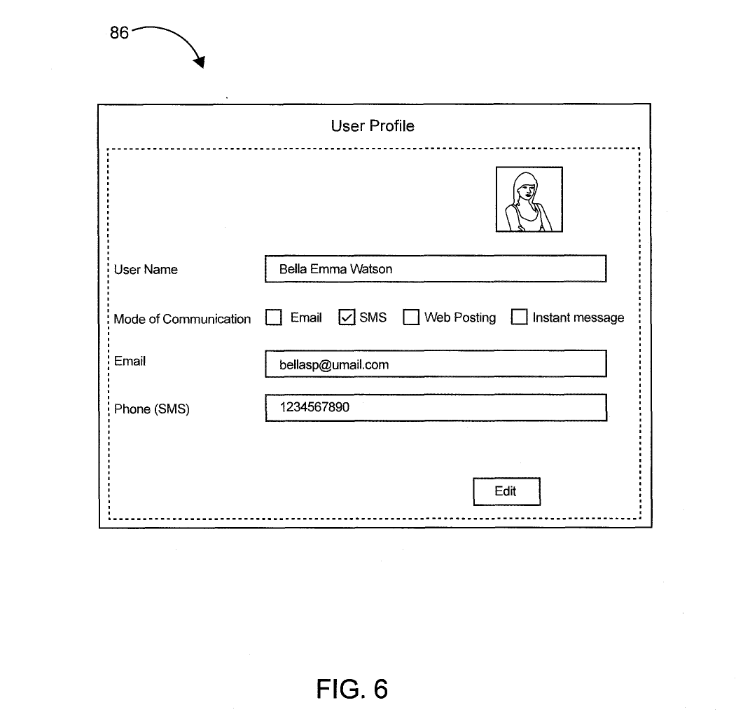

FIG. 7A shows an example of a push message received by the at least one user on a plurality of disparate communication devices 14 which is a mobile phone of the at least one user 12 and FIG. 7B shows an example of a response received by the at least one user 88. Here, the message. “Hello Joe, thanks for using our service. Did you enjoy the show? (Please rate).” is displayed, and the options 1.—I enjoyed it. 2.—ok. 3.—did not enjoy it are displayed. The at least one user 12 selects one of the above options, may be using a stylus, thereby sending the corresponding option as a reply to the message. Once a reply from the at least one user is received, a response is displayed on the plurality of disparate communication devices which is the mobile phone of the at least one user for the push message like “We are glad that you enjoyed the show. You just earned a discount on your next service! Keep the code 43434k to enter at checkout for your next show. Have a great evening.”

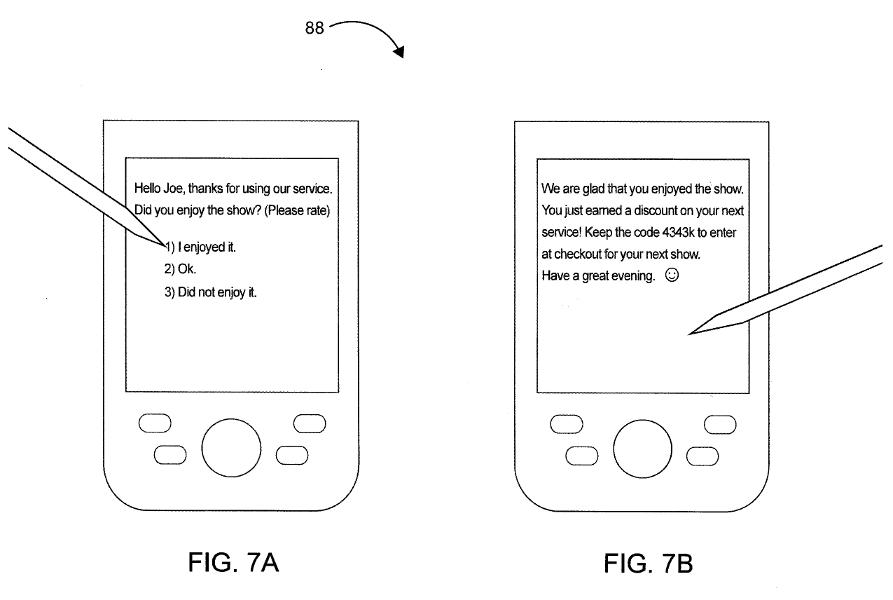

FIG. 8 illustrates a flow chart describing the working of just in time response engine. As indicated at block 70 the user or organization creates content or imports content. Block 72 shows the generation of the JIT code triggered automatically following the importation or creation of content by the user, subsequently which the user or organization clicks on the JIT code. As shown in block 74, in the content database the JIT code as well as the QR-barcodes are stored which are subsequently distributed. Thereafter, any individual with a Smartphone or any communication device can send the JIT code to the DRE or scan the QR-barcode. The JITRE launches a content session of the JIT code as depicted in block 78 thereby the at least one user gaining access to content of the desired location or organization of the JIT code as in block 80.

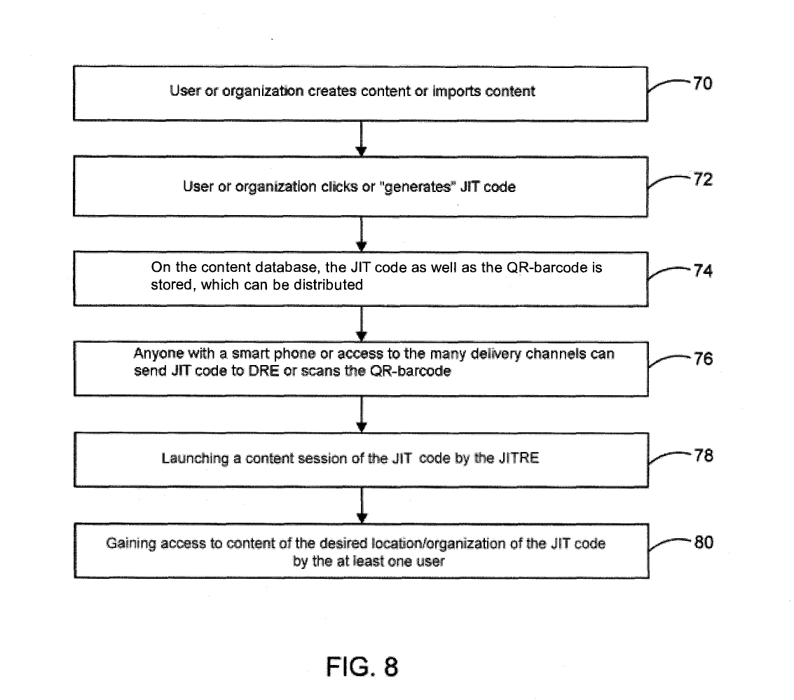

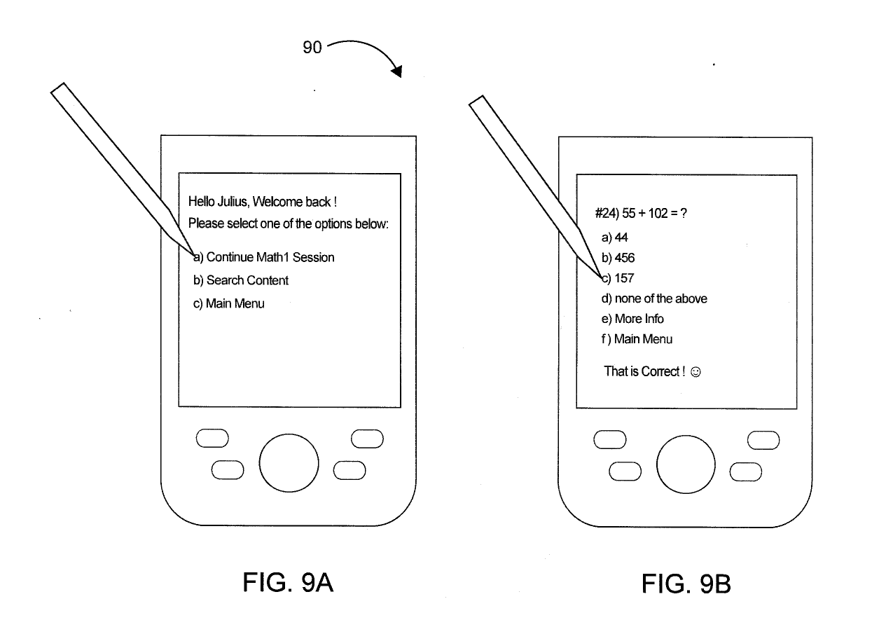

FIG. 9A shows an e-learning program in application in which a user has access to a plurality of gateways such as short message service (SMS) gateway, Email gateway, custom Instant Message (IM) gateway and Hyper Text Transfer Protocol (HTTP) gateway, or the user is connected or logged into a communication network or platform such as an online social networking site such as Facebook® that utilizes a gateway communication application. The e-learning program is attended by at least one user through a plurality of disparate communication devices which is a mobile phone of the at least one user depicting an inherent ability of a response engine to anticipate and construct an expected and coherent response dynamically to the at least one user and FIG. 9B shows a response from a response engine during an e-learning program of FIG. 9A 90. The user gains access by initiating a “short code” or SMS number, in the case of a SMS generated transaction, or in the case of email, sending a message to sign up. Other forms will require different methods of initiating the transactions. Once identified as a registered user, the transactions of communications commence. A sample communication will be generated such as: “Hello Julius, Welcome back! Please select one of the options below a.) Continue Math 1 Session b.) Search Content c.) Main Menu”. When the at least one user reply as “a”, the e-learning program continues as “#24) 55+102=? a.) 44 b.) 456 c.) 157d.) none of the above e.) More Info f.) Main Menu.

Once the message is sent, the user must select the appropriate answer. Then the DRE will generate the appropriate response based on a work flow described based on the DCML. Further series of questions will cycle and repeat.

While a particular form of the invention has been illustrated and described, it will be apparent that various modifications can be made without departing from the spirit and scope of the invention. For example, the interactive communication system 10 can be made scalable by installing services on more servers with a load balancer. Additionally, it can be made possible for a plurality of parties to load their content into the response engine 40 to provide a data that is based on a valid, standardized DCML Schema. Accordingly, it is not intended that the invention be limited, except as by the appended claims.

What is claimed is:

1. A system for data management and delivery comprising:
a plurality of disparate communication devices for engaging at least one user;
a plurality of gateways in communication with the plurality of communication devices;
a multi-channel proxy service for receiving and/or sending out at least one data through the plurality of gateways;
a response engine in communication with the multi-channel proxy for processing at least one data to the plurality of communication devices;
a message push engine in communication with the multi-channel proxy for completion and /or continuation of communication through a time tagged data management;
a message push scheduler operable with the message push engine for initializing the time tagged data management; and
a content database in communication with the response engine and the message push scheduler having a content management system;
whereby with an inherent ability, the response engine anticipates and constructs an expected and coherent response dynamically to the user by way of the multi-channel proxy service.

2. The system of claim 1 wherein the plurality of communication devices may be a mobile phone and a computer.

3. The system of claim 1 wherein the plurality of communication devices obtain messaging services from at least one instant messaging services, an short messaging services (SMS) messaging service, mobile applications and e-mail services.

4. The system of claim 1 wherein the plurality of gateways may be selected from a group consisting of an SMS gateway, instant messaging (IM) gateway and hyper text transfer protocol (HTTP) gateway, mobile applications and e-mail services.

5. The system of claim 1 wherein the multi-channel proxy service may be designed to act as a generic proxy for all messaging services.

6. The system of claim 1 wherein the response engine includes a dynamic response engine (DRE) and a just in time (JIT) response engine.

7. The system of claim 6 wherein the dynamic response engine processes, stores, scores and formats data customized to the plurality of communication devices.

8. The system of claim 6 wherein the dynamic response engine is responsible for responding to requests from the user.

9. The system of claim 6 wherein the just in time response engine launches a session for any data on demand by a code, a JIT code for example.

10. The system of claim 1 wherein the message push engine initiates communication proactively to the plurality of communication devices.

11. The system of claim 1 wherein the content database contains data selected from a group consisting of quizzes, exams, tests, surveys, polls, trivia, advertisements and the like.

12. The system of claim 1 wherein the content database contains data for responding to requests from the user and for delivery of the time tagged data management.

13. The system of claim 1 wherein the content database contains data for response engine that is responsible for responding to requests from the user.

14. A system architecture for establishing an interactive communication between a the dynamic response engine (DRE) and at least one user utilizing a plurality of disparate communication devices, the system architecture comprising:
at least one registered person as at least one user;
at least one service provider for providing access to a plurality of gateways; and
at least one content provider for adding data and making access to the at least one user;
whereby the interactive communication is achieved by the user utilizing the data from the DRE generated by a content provider employing the service provider.

15. The system of claim 14 wherein the service provider may be selected from a group consisting of: AOL®, Yahoo®, MSN® and Google®.

16. The system of claim 14 wherein the content provider may be selected from a group consisting of: bars, restaurants, law firms, advertisers and e-learning programs.

17. A method for content management and delivery application utilizing a plurality of disparate communication devices, the method comprising the steps of:
a). creating a user account with the application by at least one user at a user interface;
b). registering at the user interface by at least one content provider;
c). adding data by the content provider at a content database; and
d). making the data of interest accessible to the user upon a request by the at least one user.

18. The method of claim 17 wherein the user interface may be an application programming interface (API).

19. The method of claim 17 wherein visibility of the data accessible to the user is private.

20. The method of claim 17 wherein visibility of the data accessible to the user is public.
